(19) United States
(12) Patent Application Publication
(10) Pub. No.: US 2012/0132286 A1
(43) Pub. Date: May 31, 2012

(54) WATER-DISCHARGING DEVICE OF HIGH VOLTAGE BATTERY PACK

(75) Inventors: Haekyu Lim, Hwaseong (KR); Minwook Kim, Hwaseong (KR)

(73) Assignees: KIA MOTORS CORPORATION, Seoul (KR); HYUNDAI MOTOR COMPANY, Seoul (KR)

(21) Appl. No.: 13/281,874

(22) Filed: Oct. 26, 2011

(30) Foreign Application Priority Data
Nov. 30, 2010 (KR) 10-2010-0120728

(51) Int. Cl. G05D 9/12; B60R 11/00; B60R 5/04

(52) U.S. Cl. 137/1; 137/351; 137/396

(57) ABSTRACT

Disclosed is a water-discharging device of a high voltage battery pack that can automatically adjust the level of water collecting in an under cover such that high voltage parts, such as an expensive battery module and a BMS, equipped in the under cover are not damaged by the water, by making the BMS operate a water pump to forcibly discharge the water out of the under cover, when the water collects and increases in level in the under cover having a sealed structure.

### CROSS-REFERENCE TO RELATED APPLICATIONS

The present application claims priority to Korean Patent Application Number 10-2010-0120728 filed Nov. 30, 2010, the entire contents of which application is incorporated herein for all purposes by this reference.

### BACKGROUND OF THE INVENTION

1. Field of the Invention

The present invention relates to a water-discharging device of a high voltage battery pack, and more particularly, to a water-discharging device of a high voltage battery pack that can automatically discharge water out of an under cover when the water in the under cover is detected at a critical level.

2. Description of Related Art

Hybrid electric vehicles, fuel cell vehicles, and electric vehicles are vehicles that are all driven by electric motors and are typically equipped with a high voltage battery pack that supplies driving electricity to the electric motors. The high voltage battery pack 10, as shown in FIG. 1, includes an under cover 11 that is a box open orientated in an upward direction and sealed from the outside; a plurality of battery modules 12 mounted in the under cover 11; and a battery management system (BMS) 13 that is mounted in the under cover 11 that is configured to detect voltage, current, and temperature and control the operation of unit cells constituting battery modules 12.

The high voltage battery pack 10 including the under cover 11, as described above, is often mounted in a space of a trunk of a vehicle in order to be sealed from the outside and the under cover 11 basically has a sealed structure to prevent foreign substances and water from permeating the battery pack from the outside.

However, in the high voltage battery pack 10 of the related art, when water is produced in the under cover 11 by due condensation in winter or water flows inside through the open upper portion of under cover 11, the water cannot be discharged by itself to outside under cover 11, and thus the water collects in the under cover 11. Further, when this phenomenon continues for a long time, the level of the water increases, such that the battery modules 12, which are often expensive and the BMS 13 are damaged by the water. In other words, the high voltage battery pack 10 of the related art is not equipped with a device that can discharge water, such that it is damaged by the water.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

The present invention has been made in an effort to provide a water-discharging device of a high voltage battery pack that precludes expensive equipment from being damaged by water, by forcibly and automatically discharging water out of an under cover, when the level of the water in the under cover reaches a critical level that that would damage high voltage parts, such as a battery module and battery management system (BMS).

An exemplary embodiment of the present invention provides a water-discharging device of a high voltage battery pack, including: a plurality of water level sensors that are fixed in under cover to detect the level of water in an under cover; a BMS that is fixed in the under cover and is configured to receive water level information detected by the water level sensor, and determine whether the water level information is less or more than a reference value by comparing the water level information with the reference value; and a plurality of water dischargers that are fixed in the under cover and operated in response to a control signal from the BMS to forcibly discharge the water in the under cover to the outside.

The water level sensors may be electrostatic level sensors that transmit a change in resistance due to a change in water level, as an electric signal, to the BMS. Additionally, the water level sensors may be fixed in contact with the bottom of the under cover, and in more detail, the water level sensors may be fixed in contact with the bottom of the under cover, at the front, rear, and both sides of the under cover.

The water discharger may be a water pump that forcibly pumps up the water in the under cover and has an intake pipe and a discharging pipe that may be integrally formed to suck and discharge the water, wherein one water pump and one water level sensor embody a pair.

According to the exemplary embodiments of the present invention, it is possible to automatically adjust the level of water collecting in an under cover such that high voltage parts, such as an expensive battery module and a BMS, equipped in the under cover are not damaged by the water, by making the BMS operate a water pump to forcibly discharge the water out of the under cover, when the water collects and increases to a predetermined level in the under cover made up of a sealed structure.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a perspective view of a high voltage battery pack of the related art which is disposed in the trunk room of a vehicle.

FIG. 2 is a perspective view of a high voltage battery pack equipped with a water-discharging device according to an exemplary embodiment of the present invention.

FIG. 3 is a view showing when the under cover is removed from FIG. 2.

FIGS. 4 and 5 are views illustrating a reference value of a BMS included in the device according to the exemplary embodiment of the present invention.

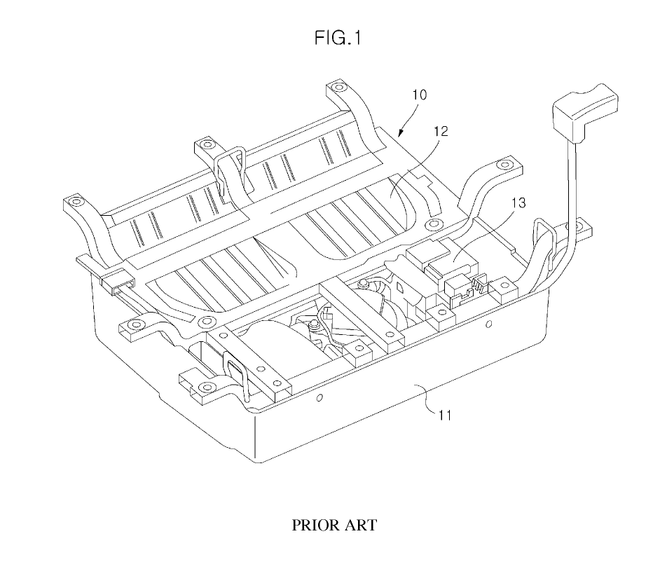

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

It is understood that the term “vehicle” or “vehicular” or other similar terms as used herein is inclusive of motor vehicles in general such as passenger automobiles including sports utility vehicles (SUV), buses, trucks, various commercial vehicles, watercraft including a variety of boats and ships, aircraft, and the like. The present systems will be particularly useful with a wide variety of motor vehicles.

Hereinafter, exemplary embodiments of the present invention will be described in detail with reference to the accompanying drawings.

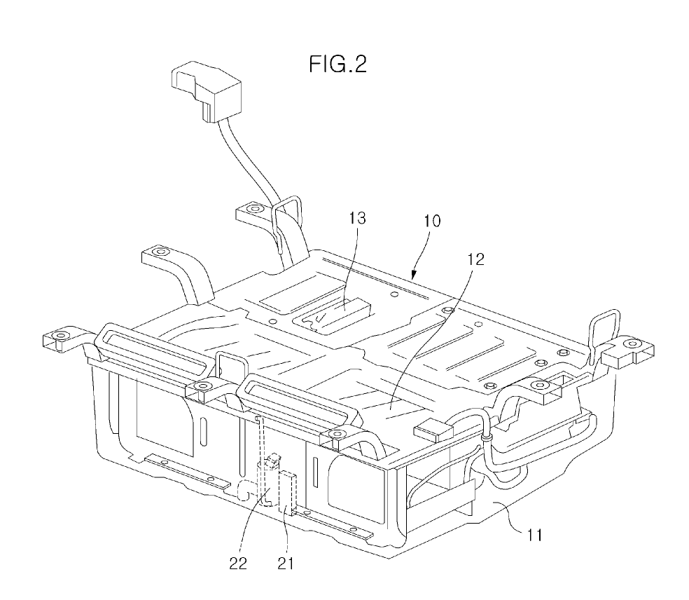

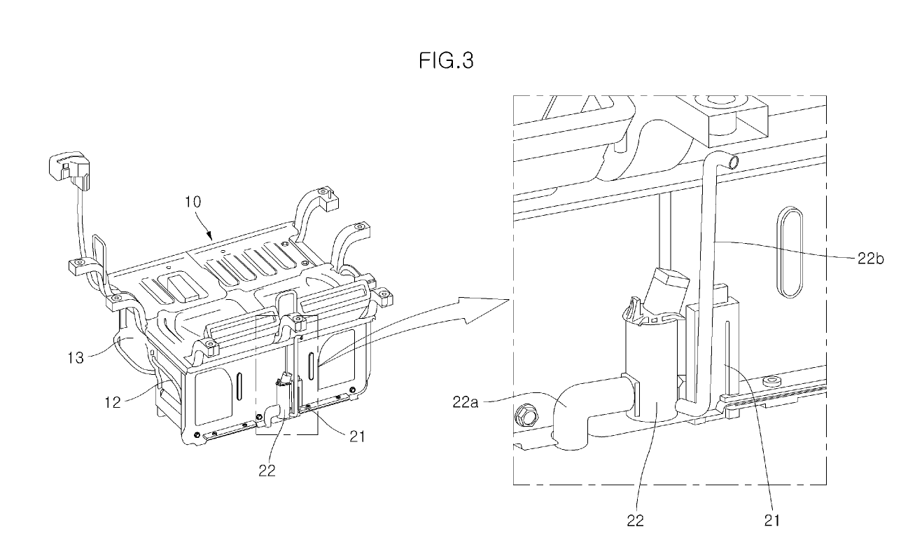

According to the exemplary embodiment of the present invention, a high voltage battery pack fixed in a space of the trunk of a vehicle having, for the most part, a sealed structure to prevent foreign substances and water from permeating from the outside. That is, a high voltage battery pack 10, as shown in FIGS. 2 and 3, includes an under cover 11 that is a box opened and orientated in the upward direction and sealed from the outside, a plurality of battery modules 12 mounted in the under cover 11, and a battery management system (BMS) 13 that is mounted in under cover 11. The BMS is configured to detect voltage, current, and temperature and control the operation of the unit cells constituting the battery modules 12.

Further, the high voltage battery pack 10 according to the exemplary embodiment of the present invention is equipped with a water-discharging device that can discharge water out of the under cover 11. More specifically, the water-discharging device includes a plurality of water level sensors 21 that are fixed in under cover 11 to detect the level of water in the under cover 11. The BMS 13 (Battery Management System) is mounted in under cover 11 and is configured to receive water level information detected by water level sensor 21 and determine whether the water level information is less or more than a reference value by comparing the water level information with the reference value. A plurality of water dischargers are fixed in the under cover 11 and are operated in response to a control signal from the BMS 13 to forcibly discharge the water in the under cover 11 to the outside.

Water level sensors 21 may be electrostatic level sensors that transmit a change in resistance due to a change in water level, as an electric signal, to the BMS 13, but is not limited thereto. Water level sensors 21 may, further, be fixed in contact with the bottom of the under cover 11, and in more detail, may be fixed in contact with the bottom of the under cover 11, at the front, rear, and both sides of the under cover 11.

The reason why the water level sensors 21 are disposed in contact with the bottom of the under cover 11 is that water exists on the bottom of the under cover 11. Further, the reason why a plurality of water level sensors 21 are provided is that the water moves on the bottom of the under cover 11 by movement of the vehicle. Therefore, the water level sensor 21 can detect the water level no matter where the water is in the under cover 11.

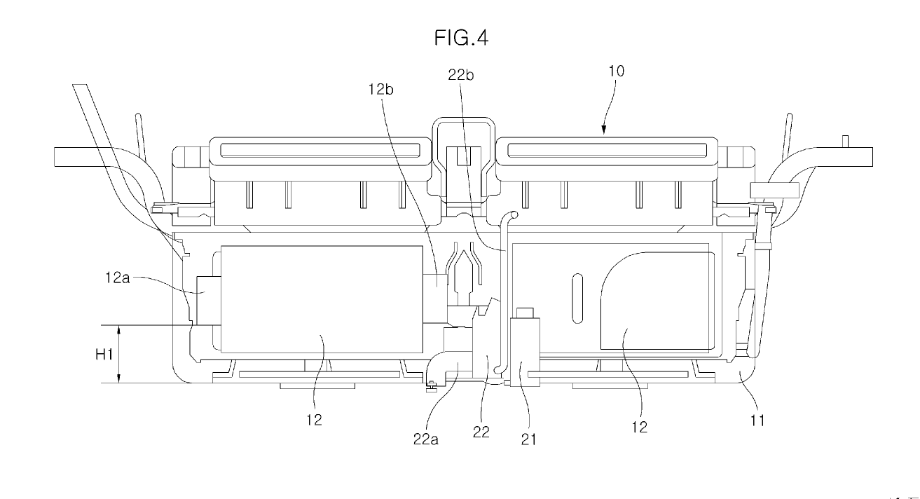

The reference value inputted in BMS 13, as shown in an example of FIG. 4, is the height H1 from the bottom of the under cover 11 of a battery module 12 equipped in the under cover 11 to terminals (12a: anode terminal and 12b: cathode terminal) of the unit cells constituting the battery module 12.

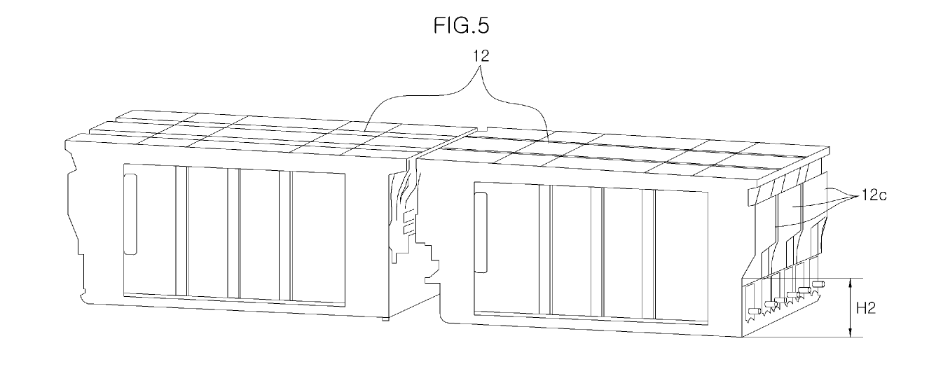

Further, the reference value inputted in the BMS 13 is the height H2 from the bottom of the under cover 11 to a cell voltage sensing connector 12c, when the cell voltage sensing connector 12c is provided in the battery module 12, in another example shown in FIG. 5. That is, when the level of the water in the under cover 11 rises above the height H1 of the fuel cell terminals 12a and 12b or the height H2 of the cell voltage sensing connector 12c, the expensive BMS equipment 13, including the battery module 12, may be damaged by the water. Thus, the reference value of the water level may be determined as the heights H1 and H2 to prevent the damage accordingly.

The water dischargers may be, for instance, water pumps 22 that can forcibly pump up the water in the under cover 11 and has an intake pipe 22a and a discharging pipe 22b that are integrally formed to suck and discharge the water, in which one water pump 22 and one water level sensor 21 may be embodied as a pair.

The operation of the exemplary embodiment of the present invention is described hereafter.

When water is produced in the under cover 11 by condensation in winter or water flows into the under cover 11 through the open upper portion from the outside, the water cannot be discharge out of the under cover 11 by the sealed structure of the under cover 11 and thus collects in the under cover 11. As the water collects in the under cover 11, water level sensors 21 detect the water level and continuously transmit information related to the level of the water to the BMS 13. Based on this information, the BMS 13 determines whether the water level information is less or more than the reference value by comparing the water level information transmitted from the water level sensors 21 with the reference value.

When BMS 13 determines that the water level information transmitted from the water level sensor 21 is more than the reference value, it operates a water pump 22 by sending a control signal, and accordingly, the water collecting in under cover is sucked through intake pipe 22a and then forcibly discharged out of the under cover 11 through the discharging pipe 22b.

Accordingly, the level of the water collecting in the under cover 11 gradually decreases and when BMS 13 receiving the corresponding water level information determines that the water level information is less than the reference value or a second reference value, the BMS stops the water pump 22 by sending a control signal.

Therefore, the exemplary embodiments of the present invention makes it possible to automatically adjust the water level in the under cover 11 by repeatedly operating the water pump 22 in accordance with the level of the water collecting in the under cover 11. Accordingly, it is possible to preclude high voltage parts, such as the expensive battery module 12 and the BMS 13 equipped in the under cover 11, from being damaged by the water.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A water-discharging device of a high voltage battery pack, comprising:
a water level sensor that is fixed in an under cover to detect the level of water in the under cover;
a battery management system (BMS) mounted in the under cover that is configured to receive water level information detected by the water level sensor, and determine whether the water level information is less or more than a reference value by comparing the water level information with the reference value; and
a plurality of water dischargers that are installed in the under cover and are operated in response to a control signal from the BMS to forcibly discharge the water in the under cover to the outside.

2. The water-discharging device of a high voltage battery pack as defined in claim 1, wherein the water level sensor is one or more electrostatic level sensors that transmit a change in resistance due to a change in water level, as an electric signal, to the BMS.

3. The water-discharging device of a high voltage battery pack as defined in claim 1, wherein the water level sensors are fixed in contact with the bottom of the under cover.

4. The water-discharging device of a high voltage battery pack as defined in claim 1, wherein the water level sensors are fixed in contact with the bottom of the under cover, at the front, rear, and both sides of the under cover.

5. The water-discharging device of a high voltage battery pack as defined in claim 1, wherein the reference value inputted into the BMS is a height from the bottom of the under cover of a battery module equipped in the under cover to terminals of the unit cells constituting the battery module.

6. The water-discharging device of a high voltage battery pack as defined in claim 1, wherein when a cell voltage sensing connector is provided in the battery module mounted in the under cover, the reference value inputted into the BMS is a height from the bottom of the under cover to the cell voltage sensing connector.

7. The water-discharging device of a high voltage battery pack as defined in claim 1, wherein the water discharger is a water pump that forcibly pumps up the water in the under cover and has an intake pipe and a discharging pipe that are integrally formed to suck and discharge the water.

8. The water-discharging device of a high voltage battery pack as defined in claim 7, wherein one water pump and one water level sensor are embodied as a pair.

9. A method for discharging water from a high voltage battery pack, comprising:
detecting a water level, by a sensor, in an undercover of the high voltage battery pack, wherein the sensor is fixed in the under cover;
transmitting the detected water level, by the sensor, to a battery management system (BMS) mounted in the under cover;
receiving water level information detected by the water level sensor at the BMS;
determining whether the water level information is less or more than a reference value by comparing the water level information with the reference value; and
in response to a control signal from the BMS to forcibly discharge the water in the under cover to the outside, operating, a plurality of water dischargers that are installed in the under cover to force the water outside of the high voltage battery pack.
